(19) United States
(12) Patent Application Publication
(10) Pub. No.: US 2026/0004141 A1
(43) Pub. Date: Jan. 1, 2026

(54) HIERARCHICAL AUTO EVALUATION OF GENERATIVE AI SYSTEMS

(71) Applicant: INTUIT INC., Mountain View, CA (US)

(72) Inventors: Jineet Hiren DOSHI, Mountain View, CA (US); Maya Vered LIVSHITS, Mountain View, CA (US); Na XU, Mountain View, CA (US); Yuan ZHOU, Mountain View, CA (US); Jeyendran BALAKRISHNAN, Mountain View, CA (US)

(73) Assignee: INTUIT INC., Mountain View, CA (US)

(21) Appl. No.: 18/755,622

(22) Filed: Jun. 26, 2024

(51) Int. Cl. G06N 3/091

(52) U.S. Cl. CPC G06N 3/091

(57) ABSTRACT

An auto evaluation system for evaluating large language models (LLMs). The auto evaluation system loads a base auto evaluation class with core functionalities, selects one or more metrics for evaluation, extends the base auto evaluation class to create a child class with additional functionalities tailored to the selected metrics. A judge LLM receives the evaluation prompts from the auto evaluation server for response generation and computes evaluation scores for the test LLM.

### BACKGROUND

Large Language Models (LLMs) and Generative AI systems have seen a surge in popularity due to their ability to perform a wide range of tasks. These tasks include, but are not limited to, text summarization, poetry writing, question answering, and sentiment analysis. The broad intelligence capabilities of these systems make them versatile and useful across various domains. To ensure the effectiveness and reliability of these systems, evaluation mechanisms are employed. Traditional evaluation methods often involve manual evaluation by humans, which, while valuable, can be expensive and does not scale well. As a result, auto evaluation has gained traction as a more scalable and cost-effective alternative. Auto evaluation involves using a more capable LLM to evaluate another LLM, less capable LLM.

Despite the advantages of auto evaluation, it is not without its challenges. Existing auto evaluation tools and packages often support specific patterns of auto evaluation, limiting their applicability to the evaluation of specific tasks. Furthermore, some evaluation metrics require a ground truth or a reference answer to compare against, which can be challenging to obtain, especially at scale. These tools are often static in their implementation, which means they cannot easily accommodate custom evaluation patterns or the assessment of novel tasks without substantial modifications.

### SUMMARY

Embodiments disclosed herein solve the aforementioned technical problems and may provide other technical solutions as well. Contrary to conventional techniques, the disclosed solution includes a novel personalized campaign generator through deep customer learning.

An example embodiment includes An auto evaluation system for evaluating large language models (LLMs), comprising an auto evaluation server configured to initialize an auto evaluation process by loading a base auto evaluation class with core functionalities, select one or more metrics for evaluation, extend the base auto evaluation class to create a child class with additional functionalities tailored to the selected metrics, receive input data and configuration settings for the evaluation, and construct evaluation prompts using the child class based on the input data and the con-figuration settings, and a judge LLM server configured to receive the evaluation prompts from the auto evaluation server for response generation by a test LLM, parse responses from the test LLM to extract metrics, compute evaluation scores based on the extracted metrics from the test LLM, and output the evaluation scores for the test LLM.

A method for evaluating large language models (LLMs), performed by an auto evaluation server in communication with a judge LLM, the method comprising initializing an auto evaluation process by loading a base auto evaluation class with core functionalities, selecting one or more metrics for evaluation, extending the base auto evaluation class to create a child class with additional functionalities tailored to the selected metrics, receiving input data and configuration settings for the evaluation of a test LLM, constructing evaluation prompts using the child class based on the input data and the configuration settings for the test LLM, communicating the evaluation prompts to the judge LLM for response generation by the test LLM, parsing responses received from the test LLM to extract metrics, computing evaluation scores based on the extracted metrics from the test LLM, and outputting the evaluation scores for the test LLM.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 is a diagram illustrating example devices for evaluating LLMs using an auto evaluation system, according to aspects of the present disclosure.

FIG. 2 is a flowchart illustrating an example method for hierarchical auto evaluation of LLMs, according to aspects of the present disclosure.

FIG. 3 is a flowchart illustrating an example method for tailoring a base auto evaluation for a specific use case, according to aspects of the present disclosure.

FIG. 4 is a flowchart illustrating an example auto evaluation execution process for LLMs, according to aspects of the present disclosure.

FIG. 5 is a diagram of an example computing system, according to aspects of the present disclosure.

### DETAILED DESCRIPTION OF SEVERAL EMBODIMENTS

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatuses as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. It is noted that similar reference numerals and letters refer to similar items in the figures, and once an item is defined for one figure, it is possible that it need not be further discussed for the other figures.

Evaluating Large Language Models (LLMs) or Generative AI systems that use LLMs is a challenging task. Unlike traditional AI systems, generative AI systems are capable of performing a wide range of tasks like text summarization, writing poems, question & answering, sentiment analysis to name a few. Such broad intelligence capability is part of the reason why evaluating these systems is challenging. On top of that, LLM models are known to generate unexpected output sometimes such as leaking private information, hallucinating or producing harmful answers. Those aspects also need to be evaluated before putting these models in production. Also, for calculating some evaluation metrics for these AI systems, a ground truth or a reference answer is conventionally required to compare against. In practice, it is challenging to have reference answers, especially at scale. Given this, manual evaluation by humans is still valuable. However, manual evaluation by humans is expensive and does not scale well. Another solution is auto evaluation, which uses a more capable LLM to evaluate another LLM. Auto evaluation provides the benefits of human evaluation, scales better and is more cost effective. However, a challenge with auto evaluation is designing it to be easily extensible so it can support evaluation of the broad range of tasks which LLMs and Generative AI systems are capable of.

The present disclosure relates to systems and methods for evaluating the performance of LLMs and Generative AI systems. More specifically, the disclosure pertains to a hierarchical auto evaluation system that is designed to be easily extensible, allowing it to support a broad range of more specific evaluation tasks. This system is based on a base interface that encapsulates the core functionalities of auto evaluation, which can be extended to create child classes tailored to specific evaluation metrics or families of metrics.

The hierarchical auto evaluation system offers several potential benefits. For instance, it provides a flexible and scalable solution for evaluating the broad intelligence capabilities of LLMs and Generative AI systems. This flexibility is advantageous given the diverse range of tasks these systems are capable of performing. Furthermore, the system's extensibility allows for the seamless integration of new evaluation patterns, ensuring that it can adapt to the evolving landscape of LLM applications.

The hierarchical auto evaluation system may include a base interface that encapsulates the core functionalities of auto evaluation, which are distilled into a base class. This base class includes variables enabling the construction of prompts, communication with an evaluator LLM, and the computation of evaluation metrics. The base class is designed to be extended, allowing child classes to inherit its properties and methods while introducing additional functionalities tailored to specific evaluation metrics or families of metrics. This hierarchical structure ensures that the system can support a broad range of tasks by facilitating the addition of new auto evaluation patterns through subclassing.

The auto evaluation system's functionality includes an interface having variables and functions which are defined in a base class. The variables may include a prompt template, which holds the template for prompts to be sent to the evaluator LLM, and an evaluator endpoint instance, which points to the evaluator LLM's API endpoint. The functions may include: construct prompts, which integrates user-provided data into the prompt template, get auto eval responses, which sends the prompts to the evaluator LLM and retrieves its responses after performing error checks, parse responses, which extracts evaluation metrics from the LLM's responses and organizes them into a dictionary, and a compute function that invokes the other functions to calculate the auto evaluation metric and appends this value to the input data. The base class is designed to be extended by child classes that inherit its interface and can introduce additional functions or parameters specific to particular auto evaluation metrics or families of metrics. This hierarchical structure allows for the creation of new auto evaluation metrics or families by extending the base class or an existing child class, providing a flexible and reusable system. In practice, the hierarchical auto evaluation system allows users to specify the desired auto evaluation metric through a configuration file (e.g., JSON format). This configuration file includes settings that define the evaluation process, such as the name of the auto evaluation metric to be used, evaluation criteria, and thresholds. Upon receiving the configuration file, the system employs a parsing mechanism to interpret the user's selection and dynamically loads the corresponding auto evaluation class for domain-specific assessment. The selected class executed against the input data file containing the evaluation data, thereby running the core auto evaluation functions along with any metric-specific logic. This process results in the generation of auto evaluation metric scores for the evaluation data, demonstrating the system's capability to adapt to user-defined evaluation requirements and to handle evaluations across a diverse array of LLM applications.

To illustrate the practical application of the hierarchical auto evaluation system, consider a scenario where a company wants to evaluate the performance of a tax specific LLM. The company may start with and extend the base auto evaluation class to create a child class that incorporates tax-specific logic, variables, and functions. This child class may be used to construct evaluation prompts, send these prompts to an evaluator LLM, parse the responses to extract relevant metrics, and compute the final evaluation scores. As a result, the company may be able to assess the performance of the Tax LLM with high precision and domain relevance, ensuring that the LLM's outputs are accurate and compliant with tax laws and regulations.

In the context of evaluating a tax-specific LLM, the extension of the base auto evaluation class to create a child class incorporating tax-specific logic is facilitated by the user providing basic information to the system, such as tax metrics and other relevant parameters. Upon receiving this information, the system automatically extends the base evaluator, generating a tailored child class that encapsulates the tax-specific evaluation logic. This automated process leverages the user-provided information to define the scope and focus of the evaluation, ensuring that the resulting child class is precisely aligned with the domain-specific requirements of the tax LLM. Consequently, the auto evaluation system is able to conduct a thorough and accurate assessment of the tax LLM's performance, reflecting its proficiency in handling tax-related tasks.

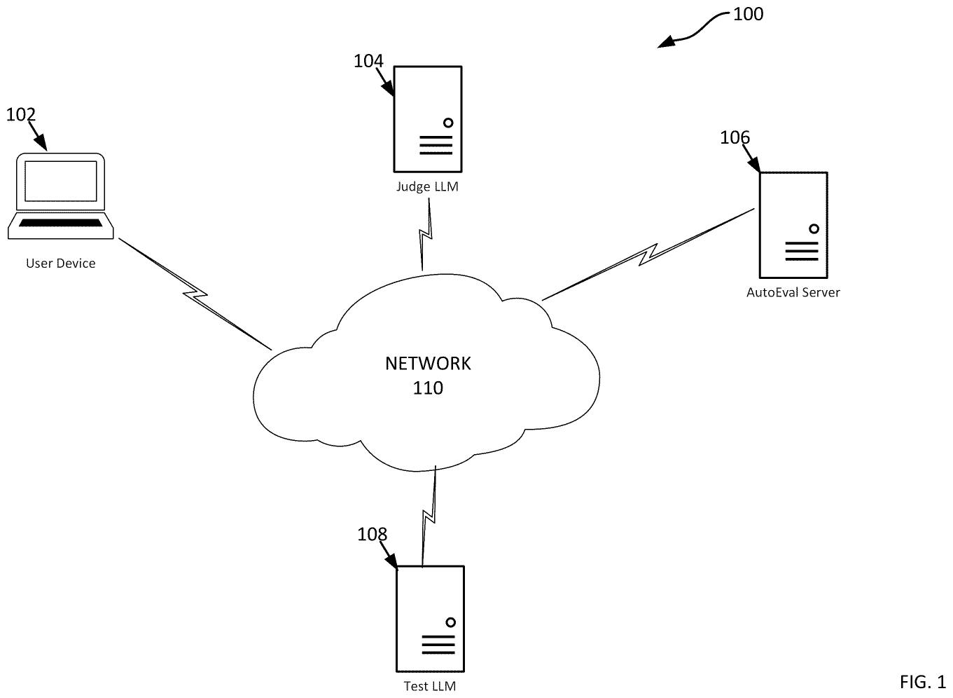

FIG. 1 is a diagram illustrating an example of a system 100 for evaluating LLMs using an auto evaluation system. The system includes a user computing device 102, a judge LLM server 104, an auto evaluation server 106, and a test LLM server 108, interconnected through a network cloud 110.

In some aspects, the user computing device 102 may initiate the evaluation process. The user computing device 102 may be any type of computing device, such as a desktop computer, a laptop, a tablet, a smartphone, or any other device capable of interacting with the network cloud 110 and the other components of the system. The user computing device 102 may be used to select the metrics for evaluation, provide input data and configuration settings, and receive the evaluation results.

The judge LLM server 104 may be a more advanced LLM that is used to evaluate the performance of the test LLM server 108. The judge LLM server 104 may receive evaluation prompts from the auto evaluation server 106, generate responses based on the prompts, and return the responses to the auto evaluation server 106. In some cases, the judge LLM server 104 may apply natural language processing (NLP) techniques to interpret the responses from the test LLM server 108, identify and categorize the extracted metrics into quantitative and qualitative data, apply statistical analysis to the extracted metrics to determine the evaluation scores, and normalize the evaluation scores to account for variations in the input data from the test LLM server 108.

The auto evaluation server 106 serves as an intermediary that facilitates the evaluation of the test LLM server 108 by the judge LLM server 104. In some cases, the auto evaluation server 106 may load the base auto evaluation class from a repository containing multiple evaluation classes and verify the compatibility of the base auto evaluation class with the auto evaluation server 106. The auto evaluation server 106 may extend the base auto evaluation class to create a child class with additional functionalities tailored to the selected metrics. The auto evaluation server 106 may also construct evaluation prompts using the child class based on the input data and the configuration settings and transmit the evaluation prompts to the judge LLM server 104 via a secure communication protocol for evaluation of the test LLM server 108. In some aspects, the auto evaluation server 106 may log details of the transmitting for audit and verification purposes.

The test LLM server 108 may be the LLM that is being evaluated. The test LLM server 108 may receive data from the user computing device 102, generate responses based on the data, and return the responses to the auto evaluation server 106 for evaluation by the judge LLM server 104.

The network cloud 110 facilitates communication between the user computing device 102, the judge LLM server 104, the auto evaluation server 106, and the test LLM server 108. The network cloud 110 may represent any type of network or combination of networks, such as a local area network (LAN), a wide area network (WAN), a wireless network, the internet, or any other type of network that enables communication between devices.

In some variations, the auto evaluation server 106 may present a user interface to a user to select the one or more metrics from a predefined list and enable the user to define custom metrics for the evaluation of the test LLM server 108. In other variations, the auto evaluation server 106 may inherit properties and methods from the base auto evaluation class and add methods for processing specific types of the input data related to the selected metrics for evaluating the test LLM server 108. In yet other variations, the auto evaluation server 106 may accept the input data in multiple formats including text, audio, and image data, and receive the configuration settings that include evaluation criteria and thresholds for the test LLM server 108. In some cases, the auto evaluation server 106 may utilize templates for generating prompts that are specific to the selected metrics for evaluating the test LLM server 108 and incorporate variability in the prompts to test different aspects of capabilities of the test LLM server 108.

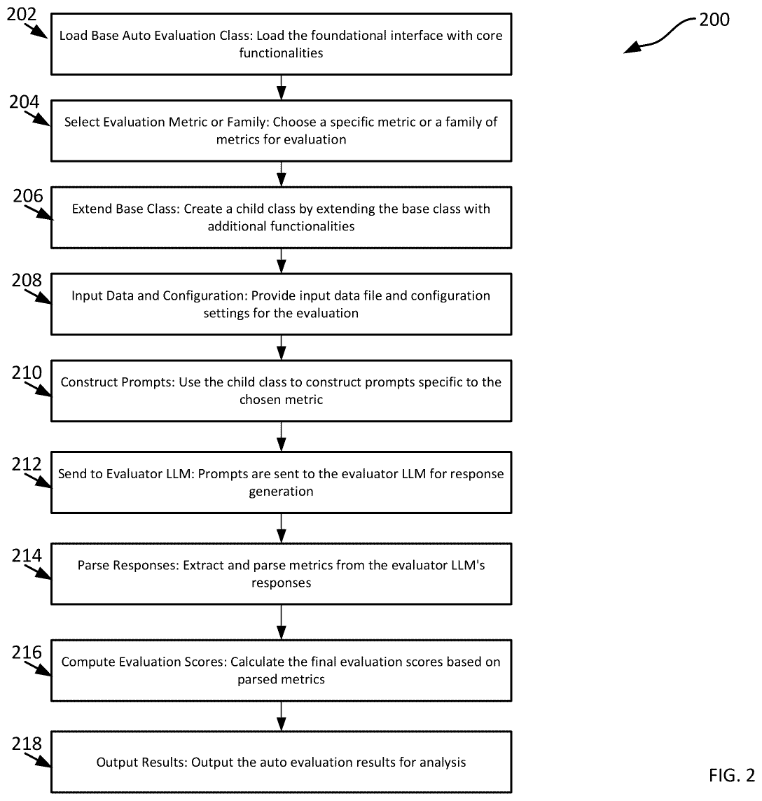

To further describe the functioning of the hierarchical auto evaluation system, FIGS. 2, 3, and 4 provide detailed flowcharts that outline the various stages and processes involved in the evaluation of LLMs. These figures collectively illustrate the systematic approach taken by the auto evaluation system to assess and quantify the performance of LLMs across different tasks and use cases.

Referring now to FIG. 2, a flowchart illustrates a process 200 for hierarchical auto evaluation of LLMs. The process 200 begins with an initialization step 202, where the base auto evaluation class is loaded, providing the foundational interface with core functionalities. In some aspects, the initialization of the auto evaluation process may involve loading the base auto evaluation class from a repository containing multiple evaluation classes and verifying the compatibility of the base auto evaluation class with the auto evaluation server.

Examples of the base auto evaluation class include a foundational interface that provides core functionalities such as input data handling, metric computation, and response analysis. This base class may offer methods for loading and parsing evaluation datasets, generating evaluation prompts, and interfacing with LLMs to receive and process their outputs. Additionally, the base class may include abstract methods for metric selection and score computation, which can be overridden by child classes to implement custom evaluation logic tailored to specific domains or tasks. The base class serves as a template from which specialized evaluation classes can be derived, ensuring a consistent and modular approach to the auto evaluation of various LLMs. In other words, the user does not have to construct an evaluation from scratch, but rather tailors the base class to a more specific domain.

A metric selection step 204 allows for the selection of a specific metric or a family of metrics for evaluation. In some cases, the selection of one or more metrics for evaluation may involve presenting a user interface to a user to select the metrics from a predefined list. In other cases, the user may be enabled to define custom metrics for the evaluation of the test LLM.

The hierarchical auto evaluation system leverages a diverse array of metrics to assess the performance of LLMs. These metrics are chosen to cover various aspects of an LLM's performance, providing a comprehensive evaluation of its capabilities.

One of the metrics used may be accuracy, which evaluates the correctness of the LLM's responses against a set of ground truth data. This metric is particularly useful in tasks where there is a correct answer, such as factual question answering or mathematical problem solving. By comparing the LLM's responses to the ground truth data, the system can quantify how often the LLM produces the correct output.

Fluency is another metric that may be used by the system. This metric assesses the naturalness and readability of the text generated by the LLM. It is especially relevant for tasks that involve generating human-like text, such as text summarization, poetry writing, or dialogue generation. The fluency metric can help determine whether the LLM's output is grammatically correct, logically structured, and easy to read, which are indicators of a high-quality text generation.

Coherence is a further metric that the system may use to evaluate how well the LLM's outputs are logically connected and contextually relevant. This metric is particularly useful for tasks that require the LLM to maintain a consistent line of reasoning or to generate a coherent narrative, such as story generation or long-form question answering. By assessing the coherence of the LLM's output, the system can determine whether the LLM is able to maintain a logical flow in its responses and stay on topic.

In addition to these general metrics, the hierarchical auto evaluation system also employs domain-specific metrics for evaluations in specific fields, such as legal or medical fields. These metrics may include compliance with industry standards, precision in using technical vocabulary, and the ability to provide reliable information based on current regulations. For instance, in a legal context, the system might evaluate whether the LLM correctly applies legal principles, accurately references case law, and provides advice that is in compliance with current legislation. In a medical context, the system might assess whether the LLM uses medical terminology accurately, provides information that is consistent with current medical guidelines, and generates advice that is safe and reliable.

In either case, the metrics are used to construct evaluation prompts, which are processed by the LLMs to generate responses. These responses are analyzed to compute the final evaluation scores. By using a diverse array of metrics to construct the evaluation prompts, the system ensures that the LLM is tested on a wide range of tasks and capabilities. This approach provides a comprehensive assessment of the LLM's performance, ensuring that the evaluation results are both accurate and meaningful.

The process proceeds to a class extension step 206, where a child class is created by extending the base class with additional functionalities tailored to the chosen metric. The extension of the base auto evaluation class to create a child class may involve inheriting properties and methods from the base auto evaluation class and adding methods for processing specific types of the input data related to the selected metrics for evaluating the test LLM.

The creation of a child class by extending the base auto evaluation class enables the customization of the evaluation process to suit specific metrics. This extension process begins with the inheritance of the base class's core functionalities, which include generic methods for handling input data, generating evaluation prompts, and analyzing LLM outputs.

The base class's core functionalities serve as the foundation upon which the child class is built. These functionalities are designed to be universally applicable across a wide range of tasks and domains, providing a robust and flexible starting point for the creation of specialized evaluation classes. The handling of input data involves the processing and formatting of the data to be evaluated, ensuring that it is in a suitable form for the evaluation process. The generation of evaluation prompts involves the creation of queries or tasks that are designed to test the capabilities of the LLM. The analysis of LLM outputs involves the interpretation and assessment of the LLM's responses to the evaluation prompts.

To these foundational functionalities, additional methods and properties are added, which are specifically designed to process and evaluate the test LLM based on the selected metrics. These additional methods and properties are tailored to the specific requirements of the chosen metrics, enabling a more focused and relevant evaluation of the LLM's performance. For instance, if the chosen metric pertains to legal reasoning, the child class may incorporate legal-specific variables, logic, and functions that can accurately assess the LLM's performance in legal contexts.

Legal-specific variables may include legal terms, case law references, and legal principles. Legal-specific logic may involve the application of legal reasoning techniques, such as statutory interpretation or case law analysis. Legal-specific functions may include the generation of legal scenarios or the formulation of legal arguments. By incorporating these legal-specific elements, the child class is able to conduct a thorough and accurate evaluation of the LLM's legal reasoning capabilities.

This tailored child class thus becomes a specialized tool for evaluating the test LLM, capable of generating domain-relevant prompts, parsing nuanced responses, and computing scores that reflect the LLM's proficiency in the targeted domain. The generation of domain-relevant prompts ensures that the LLM is tested on tasks that are relevant and applicable to the specific domain. The parsing of nuanced responses allows for a more detailed and insightful analysis of the LLM's outputs, taking into account the subtleties and complexities of the domain. The computation of scores provides a quantitative measure of the LLM's performance, enabling a clear and objective assessment of its proficiency in the targeted domain.

In this way, the hierarchical auto evaluation system provides a flexible and adaptable framework for the evaluation of LLMs, capable of accommodating a wide range of tasks and domains.

A data input step 208 involves providing an input data file and configuration settings for the evaluation. In some aspects, the receiving of input data and configuration settings for the evaluation of a test LLM may involve accepting the input data in multiple formats including text, audio, and image data. The configuration settings that include evaluation criteria and thresholds for the test LLM may also be received.

In this step, the user provides the system with the data that will be used for the evaluation process. This data is typically provided in the form of an input data file. The input data file contains the data that the test LLM has responded to or will respond to. This data serves as the basis for the evaluation prompts that will be constructed. The data can be in various formats such as text, audio, or image data, providing flexibility in the type of data that can be evaluated. For instance, text data may be a piece of written content, audio data may be a recorded speech or conversation, and image data may be a picture or a diagram that the LLM is expected to interpret or describe.

Alongside the input data file, the user also provides configuration settings for the evaluation. These settings are typically provided in a configuration file. The configuration file contains various settings that dictate the evaluation process. These settings include the evaluation criteria and thresholds for the test LLM. The evaluation criteria define what aspects of the LLM's performance are being evaluated. For example, the criteria may include the accuracy of the LLM's responses, the relevance of the responses to the prompts, the fluency of the generated text, among others. The thresholds, on the other hand, define the acceptable levels of performance for each criterion. For instance, a threshold may be set to determine what constitutes an accurate response or a fluent text. The configuration settings allow the user to customize the evaluation process according to their specific requirements and expectations.

The process proceeds to a prompt construction step 210, where the child class, which has been tailored with additional functionalities specific to the chosen metric, is utilized to construct evaluation prompts. These prompts are carefully designed queries or tasks that are used to test the capabilities of the LLM under evaluation. The construction of these evaluation prompts influences the quality and relevance of the LLM's responses, which in turn impacts the accuracy of the evaluation results.

The construction of evaluation prompts using the child class involves a two-fold process. Firstly, it may involve utilizing templates for generating prompts that are specific to the selected metrics for evaluating the test LLM. These templates are predefined structures or formats that guide the construction of the prompts, ensuring that they are aligned with the evaluation criteria defined by the selected metrics. For instance, if the selected metric pertains to the LLM's ability to generate coherent and grammatically correct sentences, the prompt templates may be designed to elicit complex sentence structures or specific grammatical constructs from the LLM.

Secondly, the construction of evaluation prompts may also involve incorporating variability in the prompts to test different aspects of the capabilities of the test LLM. This variability is introduced to ensure that the LLM is evaluated across a diverse range of tasks and scenarios, providing a comprehensive assessment of its capabilities. For example, the prompts may vary in complexity, topic, style, or format, challenging the LLM to adapt its responses to different contexts and requirements. This variability in the prompts not just tests the versatility of the LLM but also its ability to handle unexpected or novel tasks, which is a beneficial attribute in the dynamic and evolving landscape of LLM applications.

In this way, the child class plays a central role in the auto evaluation process, enabling the construction of tailored and variable prompts that effectively assess the performance of the LLM against the chosen metrics.

The process proceeds to an evaluator LLM communication step 212, where the constructed prompts are dispatched to an evaluator LLM for response generation. The evaluator LLM, often a more advanced model, plays the role of a judge, assessing the responses of the test LLM based on the prompts it receives. This communication of the evaluation prompts to the judge LLM sets the stage for the generation of responses that will be used to evaluate the performance of the test LLM.

The transmission of the evaluation prompts to the judge LLM is carried out via a secure communication protocol. This ensures the integrity and confidentiality of the evaluation data, safeguarding it from potential security threats. The secure communication protocol may be any protocol that provides data encryption and secure data transfer, such as Secure Sockets Layer (SSL) or Transport Layer Security (TLS). This secure transmission is particularly relevant when the evaluation data contains sensitive information or when the evaluation is being conducted in a distributed or cloud-based environment where data security is desirable.

In addition to transmitting the evaluation prompts, the auto evaluation system also logs the details of the transmission. This includes information such as the time of transmission, the size of the data transmitted, the destination of the transmission, and any errors or issues encountered during the transmission. This logging serves multiple purposes. Firstly, it provides a record of the evaluation process, which can be useful for audit and verification purposes. Secondly, it can help in troubleshooting and resolving any issues that might arise during the evaluation process. Lastly, it can provide beneficial insights into the performance and efficiency of the auto evaluation system, which can be used to further optimize and improve the system.

Once the evaluator LLM has generated responses to the prompts, the system proceeds to the response parsing step 214. This step involves extracting and parsing metrics from the evaluator LLM's responses. The metrics extracted during this step provide the raw data that will be used to compute the final evaluation scores.

The parsing of responses received from the test LLM to extract metrics is a process that may involve the application of NLP techniques. NLP is a branch of artificial intelligence that deals with the interaction between computers and humans through natural language. An objective of NLP is to read, decipher, understand, and make sense of human language in a beneficial way. In the context of the auto evaluation system, NLP techniques are used to interpret the responses from the test LLM. These techniques can help the system understand the context, semantics, and sentiment of the responses, which are beneficial information for the evaluation process.

The system identifies and categorizes the extracted metrics into quantitative and qualitative data for the test LLM. Quantitative data refers to numerical data that can be measured or counted. In the context of LLM evaluation, quantitative data may include metrics such as the accuracy of the LLM's responses, the speed of response generation, or the length of the generated responses. On the other hand, qualitative data refers to non-numerical data that provides descriptive information. For LLM evaluation, qualitative data may include metrics such as the coherence of the LLM's responses, the relevance of the responses to the prompts, or the fluency of the generated text. Both types of data are beneficial for a comprehensive evaluation of the LLM's performance.

The process continues with a score computation step 216, where the final evaluation scores are calculated based on the parsed metrics. The computation of evaluation scores based on the extracted metrics from the test LLM may involve applying statistical analysis to the extracted metrics from the test LLM to determine the evaluation scores and normalizing the evaluation scores to account for variations in the input data from the test LLM.

The process proceeds with a results output step 218, where the auto evaluation results are outputted for analysis. This step brings together the various components of the auto evaluation process to produce a comprehensive evaluation of the test LLM's performance. The outputting of the evaluation scores for the test LLM may involve displaying the evaluation scores for the test LLM in a user interface. This may be a graphical user interface (GUI) that presents the evaluation scores in a visually intuitive manner, making it easy for users to understand and interpret the results. The user interface may also provide interactive features that allow users to explore the evaluation results in more detail, such as by viewing the scores for individual metrics or by comparing the scores across different LLMs or evaluation runs.

In addition to displaying the evaluation scores in a user interface, the results output step may also involve generating a detailed report that includes the evaluation scores and an analysis of the performance of the test LLM. This report may provide a comprehensive overview of the test LLM's performance, detailing how the LLM performed on each metric and highlighting any areas of strength or weakness. The report may also include a summary of the evaluation process, outlining the metrics used, the evaluation prompts generated, and the responses received from the test LLM. This detailed report serves as a beneficial resource for users, providing them with a thorough understanding of the test LLM's capabilities and performance. It can be used for various purposes, such as for reviewing the LLM's performance, for making decisions about deploying or improving the LLM, or for sharing the evaluation results with other stakeholders.

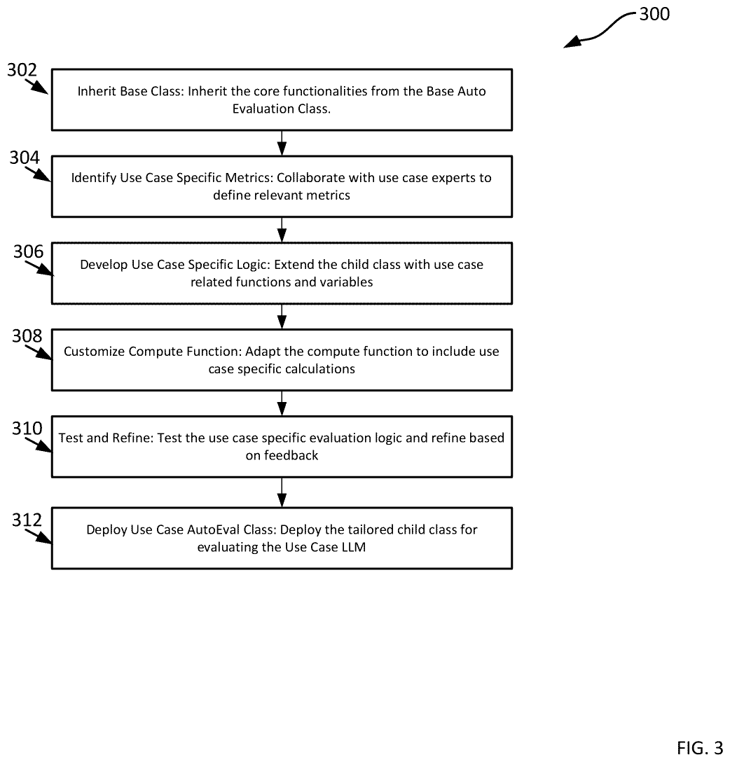

Referring now to FIG. 3, a flowchart illustrates a method 300 for tailoring a base auto evaluation for an example use case.

The method 300 commences with an inheritance step 302 where the core functionalities from the base auto evaluation class are inherited. This inheritance is a foundational aspect of the hierarchical structure of the auto evaluation system, as it allows for the creation of specialized child classes that build upon the base class's core functionalities.

The base auto evaluation class encapsulates the core functionalities that are universally applicable to the auto evaluation of any LLM. These functionalities form the foundation of the auto evaluation process, providing the basic mechanisms for handling input data, generating evaluation prompts, and analyzing LLM responses. By inheriting these core functionalities, the child classes gain a robust and flexible starting point for the creation of specialized evaluation logic.

The inheritance step 302 may involve loading the base auto evaluation class from a repository containing multiple evaluation classes. This repository may be a local or remote database, a cloud-based storage system, or any other type of data storage system that houses the various evaluation classes. The base auto evaluation class is selected from this repository and loaded into the auto evaluation server, preparing it for the extension process.

Once the base auto evaluation class is loaded, the compatibility of the base auto evaluation class with the auto evaluation server is verified. This verification ensures that the base class can function correctly within the auto evaluation server's environment and that it is compatible with the server's hardware and software configurations. This compatibility check is a safeguard that helps prevent potential issues or errors during the auto evaluation process.

In some aspects, the base auto evaluation class may provide the foundational interface with core functionalities that are universally applicable to the auto evaluation of any LLM. This foundational interface encapsulates the basic mechanisms of the auto evaluation process, providing a standardized and consistent approach to evaluating LLMs. By inheriting this foundational interface, the child classes gain a robust and flexible starting point for the creation of specialized evaluation logic. This inheritance forms the basis of the hierarchical structure of the auto evaluation system, enabling the seamless integration of new evaluation patterns and the creation of specialized child classes tailored to specific evaluation metrics or families of metrics.

The system proceeds to the metrics identification step 304. This step is a collaborative process that involves working with experts in the specific use case to define the metrics that will be used for evaluation. The selection of these metrics can be done in several ways. In some instances, the system may present a user interface to the user, allowing them to select the desired metrics from a predefined list. This list may include a wide range of general and domain-specific metrics, providing the user with a comprehensive selection to choose from.

In other cases, the system may enable the user to define custom metrics for the evaluation. This feature is particularly useful when the use case involves a specialized task or domain that may benefit from specific evaluation criteria. By allowing the user to define custom metrics, the system ensures that the evaluation is tailored to the specific requirements of the test LLM and the task it is performing.

For instance, if the use case involves evaluating a Tax LLM, tax experts may collaborate with programmers to identify the metrics that are relevant to evaluating the performance of a Tax LLM. These experts bring their domain-specific knowledge and expertise to the table, ensuring that the selected metrics accurately reflect the performance criteria relevant to tax-related tasks.

The metrics for a Tax LLM may include a variety of factors such as the accuracy in calculating tax liabilities, the understanding of tax legislation, and the ability to handle complex tax-related queries. The accuracy metric may assess how accurately the LLM calculates tax liabilities based on the given data. The understanding metric may evaluate the LLM's comprehension and application of tax legislation in its responses. The complexity handling metric may measure the LLM's ability to handle and respond to complex tax-related queries.

By collaborating with use case experts and allowing for the definition of custom metrics, the system ensures that the evaluation process is tailored to the specific requirements of the use case, providing a more accurate and relevant assessment of the LLM's performance.

The logic development step 306 is a phase in the hierarchical auto evaluation process that involves extending the child class with functions and variables that are specific to the use case at hand. The extension of the base auto evaluation class to create a child class is a multi-faceted process. It begins with inheriting the properties and methods from the base auto evaluation class. These properties and methods form the foundational structure of the child class, providing it with the core functionalities that are universally applicable to the auto evaluation of any LLM.

Once the foundational structure of the child class is established, additional methods are added to process specific types of input data. These methods are tailored to the selected metrics for evaluating the test LLM. They are designed to handle the nuances of the input data, ensuring that the data is processed in a manner that aligns with the evaluation criteria defined by the selected metrics.

For instance, in the case of a Tax LLM, the child class may be extended with tax-specific logic. This involves adding tax-specific variables to the child class. These variables may include tax codes, regulations, or case law references. These tax-specific variables serve as the building blocks for the evaluation prompts, providing the context and content for the prompts.

In addition to adding tax-specific variables, functions are developed that can construct tax-related prompts. These functions are more nuanced and may require domain expertise to accurately reflect the complexities of tax-related tasks. They are designed to generate prompts that test the Tax LLM's ability to interpret and apply tax codes, comply with regulations, and reference case law in its responses.

Through the logic development step 306, the child class is effectively tailored to the specific requirements of the use case, enabling a more focused and relevant evaluation of the test LLM's performance. This step exemplifies the flexibility and adaptability of the hierarchical auto evaluation system, demonstrating its ability to accommodate a wide range of tasks and domains.

The compute customization step 308 is a phase in the hierarchical auto evaluation process that involves adapting the compute function, a core component of the child class, to include calculations that are specific to the use case at hand. The compute function is a versatile component that is designed to be easily customizable, allowing it to incorporate a wide range of use case-specific metrics into the evaluation process. This customization may involve complex calculations that are tailored to the specific requirements of the use case, or comparisons against use case-specific databases that contain reference data or benchmark values.

For instance, in the case of a Tax LLM, the compute function may be adapted to include calculations related to tax liabilities. These calculations may involve determining the tax liability based on the income and deductions data provided in the input data file and comparing the calculated tax liability against the tax liability reported by the Tax LLM. This comparison may provide a quantitative measure of the Tax LLM's accuracy in calculating tax liabilities, which is a beneficial metric for evaluating its performance.

In addition to tax liability calculations, the compute function may also be adapted to include comparisons against tax law databases. These databases may contain information about tax laws, regulations, and case law references that are relevant to the tax scenarios presented in the evaluation prompts. The Tax LLM's responses may be compared against these databases to assess its understanding and application of tax laws and regulations. This comparison may provide a qualitative measure of the Tax LLM's proficiency in handling tax-related tasks, which is another beneficial metric for evaluating its performance.

Through the compute customization step 308, the hierarchical auto evaluation system is able to conduct a thorough and accurate assessment of the test LLM's performance, reflecting its proficiency in handling use case-specific tasks. This step exemplifies the flexibility and adaptability of the hierarchical auto evaluation system, demonstrating its ability to accommodate a wide range of tasks and domains.

The testing and refinement step 310 is where the use case specific evaluation logic is tested and refined based on feedback. The use case-specific auto evaluation logic may be tested with a variety of use case scenarios to ensure that the evaluation is accurate and reliable. Feedback from these tests may be used to refine the evaluation logic further. For example, in the case of a Tax LLM, the tax-specific auto evaluation logic may be tested with a variety of tax scenarios, and the feedback from these tests may be used to refine the tax-specific evaluation logic.

The testing and refinement step 310 is a phase in the hierarchical auto evaluation process that involves the rigorous testing of the use case-specific auto evaluation logic across a variety of scenarios pertinent to the use case. The objective of this testing is to ensure that the evaluation logic is not just theoretically sound but also practically effective in accurately and reliably evaluating the performance of the LLM in real-world scenarios.

The testing process involves simulating a range of scenarios that the LLM might encounter in its operational environment. These scenarios are designed to challenge the LLM's capabilities and test the robustness of the evaluation logic. The LLM's responses to these scenarios are evaluated using the use case-specific auto evaluation logic, and the results are analyzed to assess the accuracy and reliability of the evaluation.

Feedback from these tests plays a role in refining the evaluation logic. This feedback may come from various sources, such as the results of the tests, observations made during the testing process, or input from domain experts. The feedback provides beneficial insights into the strengths and weaknesses of the evaluation logic, highlighting areas where the logic performs well and areas where improvements may be beneficial.

For instance, in the case of a Tax LLM, the tax-specific auto evaluation logic may be tested with a variety of tax scenarios. These scenarios may include simple tax calculations, complex tax planning scenarios, or situations involving ambiguous tax laws. The Tax LLM's responses to these scenarios may be evaluated using the tax-specific auto evaluation logic, and the results may be analyzed to assess the logic's accuracy and reliability in evaluating the LLM's performance.

The feedback from these tests is used to refine the tax-specific evaluation logic. This may involve adjusting the evaluation criteria, modifying the computation methods, or adding new metrics to better capture the LLM's performance in tax-related tasks. Through this iterative process of testing and refinement, the tax-specific auto evaluation logic is continually improved, ensuring that it remains effective and relevant in the face of evolving tax scenarios and LLM capabilities.

The deployment step 312 involves the utilization of the tailored child class for the evaluation of the specific use case LLM. This step signifies the culmination of the process where the child class, now fully developed and tested, is ready to be deployed for the evaluation of the LLM designed for a specific use case.

The deployment of the child class enables the automatic evaluation of the use case LLM, thereby facilitating a rapid and scalable assessment of the LLM's performance. This is an advantage as it allows for the evaluation of the LLM's capabilities in a timely and efficient manner, which is particularly beneficial in scenarios where a large number of LLMs are to be evaluated or where the evaluation process is to be repeated at regular intervals.

For instance, consider the scenario where the use case-specific auto evaluation class has been tailored for the evaluation of a Tax LLM. Once this tax-specific auto evaluation class has been fully developed, tested, and refined, it can be deployed to automatically evaluate the Tax LLM. The deployment of this tailored child class enables the system to assess the Tax LLM's performance in handling tax-related tasks, such as calculating tax liabilities, interpreting tax legislation, and responding to complex tax-related queries.

The deployment of the tax-specific auto evaluation class ensures that the Tax LLM's outputs are evaluated against the specific requirements and standards of the tax domain. This includes checking the accuracy of the tax calculations made by the LLM, the correctness of its interpretations of tax laws and regulations, and its ability to provide accurate and compliant tax advice.

By deploying the tailored child class for the evaluation of the Tax LLM, the hierarchical auto evaluation system ensures that the LLM's outputs are not just accurate, but also compliant with tax laws and regulations. This ensures that the advice and services provided by the Tax LLM are reliable, accurate, and legally compliant, thereby minimizing the risk of errors and legal issues.

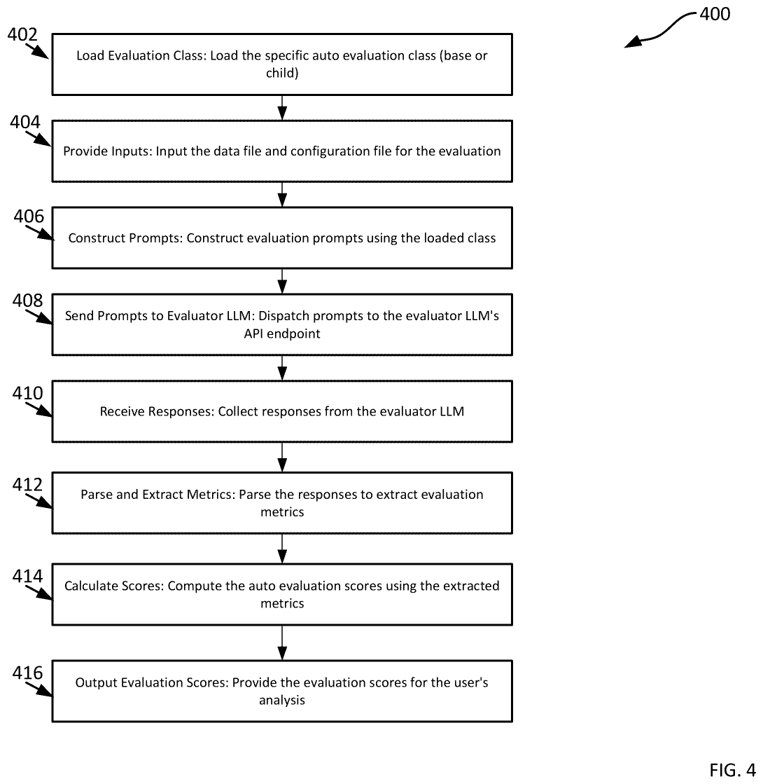

Referring now to FIG. 4, a flowchart 400 illustrates the auto evaluation execution process for LLMs.

The process begins with the evaluation class loading step 402, where the specific auto evaluation class, which may be either the base class or a child class, is loaded. In some aspects, the auto evaluation class may be loaded from a repository containing multiple evaluation classes. The compatibility of the loaded auto evaluation class with the auto evaluation server may also be verified during this step.

The evaluation class loading step 402 is the initial phase of the auto evaluation execution process. In this step, the specific auto evaluation class, which may be either the base class or a child class, is loaded into the system. The base class represents the foundational interface with core functionalities that are universally applicable to the auto evaluation of any LLM. On the other hand, a child class is a specialized version of the base class, extended with additional functionalities tailored to a specific metric or a family of metrics.

The auto evaluation class is typically loaded from a repository that houses multiple evaluation classes. This repository may be a local or remote database, a cloud-based storage system, or any other type of data storage system. The repository provides a centralized location for storing and managing the various evaluation classes, making it easy to load the appropriate class when initiating the auto evaluation process.

Once the specific auto evaluation class is loaded, the system verifies its compatibility with the auto evaluation server. This verification process ensures that the loaded class can function correctly within the server's environment and is compatible with the server's hardware and software configurations. This compatibility check is a safeguard that helps prevent potential issues or errors during the auto evaluation process. It ensures that the loaded class is capable of interfacing correctly with the evaluator LLM, constructing the evaluation prompts, parsing the LLM's responses, and computing the final evaluation scores.

In essence, the evaluation class loading step 402 sets the stage for the auto evaluation process, ensuring that the system is equipped with the right class and that the class is fully compatible with the auto evaluation server.

In the evaluation class loading step 402, the process advances to the input data provision step 404. This step involves the provision of the data file and configuration file that are beneficial to the evaluation. The data file is a comprehensive collection of data that the test LLM has responded to or will respond to. This data serves as the basis for the evaluation prompts that will be constructed. The data file may contain a wide range of data types, including but not limited to text, audio, and image data. For instance, text data may be a piece of written content, audio data may be a recorded speech or conversation, and image data may be a picture or a diagram that the LLM is expected to interpret or describe.

In addition to the data file, the configuration file is also provided. The configuration file is a document that contains the settings for the evaluation. These settings dictate the evaluation process and include parameters such as the evaluation criteria and thresholds. The evaluation criteria define what aspects of the LLM's performance are being evaluated. For example, the criteria may include the accuracy of the LLM's responses, the relevance of the responses to the prompts, the fluency of the generated text, among others. The thresholds, on the other hand, define the acceptable levels of performance for each criterion. For instance, a threshold may be set to determine what constitutes an accurate response or a fluent text.

In some cases, the input data may be accepted in multiple formats, providing flexibility in the type of data that can be evaluated. This flexibility is particularly advantageous given the diverse range of tasks that LLMs are capable of performing. By accepting data in multiple formats, the auto evaluation system ensures that it can accommodate a wide range of tasks and domains, providing a comprehensive assessment of the LLM's performance.

During the prompt construction step 406, evaluation prompts are constructed using the loaded class. The prompts may be generated based on the input data and the configuration settings. In some aspects, templates may be utilized for generating prompts that are specific to the selected metrics for evaluating the LLM. Variability may also be incorporated in the prompts to test different aspects of the capabilities of the LLM.

In this step, the loaded class, which may be either the base class or a child class tailored to a specific metric or family of metrics, is used to construct the evaluation prompts. These prompts are carefully designed queries or tasks that are used to test the capabilities of the LLM under evaluation. The construction of these evaluation prompts directly influences the quality and relevance of the LLM's responses, which in turn impacts the accuracy of the evaluation results.

The prompts are generated based on the input data and the configuration settings provided by the user. The input data contains the data to be evaluated, which serves as the basis for the evaluation prompts. The configuration settings, on the other hand, dictate the evaluation process and include parameters such as the evaluation criteria and thresholds. These settings guide the construction of the prompts, ensuring that they align with the evaluation criteria and thresholds defined by the user.

In some aspects, templates may be utilized for generating prompts that are specific to the selected metrics for evaluating the LLM. These templates are predefined structures or formats that guide the construction of the prompts, ensuring that they are aligned with the evaluation criteria defined by the selected metrics. For instance, if the selected metric pertains to the LLM's ability to generate coherent and grammatically correct sentences, the prompt templates may be designed to elicit complex sentence structures or specific grammatical constructs from the LLM.

Furthermore, variability may also be incorporated in the prompts to test different aspects of the capabilities of the LLM. This variability is introduced to ensure that the LLM is evaluated across a diverse range of tasks and scenarios, providing a comprehensive assessment of its capabilities. For example, the prompts may vary in complexity, topic, style, or format, challenging the LLM to adapt its responses to different contexts and requirements. This variability in the prompts not just tests the versatility of the LLM but also its ability to handle unexpected or novel tasks, which is a beneficial attribute in the dynamic and evolving landscape of LLM applications.

The process proceeds with the evaluator LLM dispatch step 408, where the constructed prompts are dispatched to the evaluator LLM's API endpoint. The evaluator LLM may be a more advanced LLM that is used to evaluate the performance of the test LLM. The prompts may be transmitted to the evaluator LLM via a secure communication protocol for evaluation of the test LLM. In some cases, details of the transmitting may be logged for audit and verification purposes.

In the evaluator LLM dispatch step 408, the constructed prompts, which are specifically designed to test the capabilities of the test LLM, are dispatched to the evaluator LLM's API endpoint. The evaluator LLM, often a more advanced model, plays the role of a judge, assessing the responses of the test LLM based on the prompts it receives. This communication of the evaluation prompts to the judge LLM sets the stage for the generation of responses that will be used to evaluate the performance of the test LLM.

The prompts are transmitted to the evaluator LLM via a secure communication protocol. This ensures the integrity and confidentiality of the evaluation data, safeguarding it from potential security threats. The secure communication protocol may be any protocol that provides data encryption and secure data transfer, such as SSL and TLS. This secure transmission is particularly relevant when the evaluation data contains sensitive information or when the evaluation is being conducted in a distributed or cloud-based environment where data security is desired.

In addition to transmitting the evaluation prompts, the auto evaluation system also logs the details of the transmission. This includes information such as the time of transmission, the size of the data transmitted, the destination of the transmission, and any errors or issues encountered during the transmission. This logging serves multiple purposes including providing a record of the evaluation process, which can be useful for audit and verification purposes, providing aid in troubleshooting and resolving any issues that might arise during the evaluation process, and providing beneficial insights into the performance and efficiency of the auto evaluation system, which can be used to further optimize and improve the system.

The system proceeds to the response collection step 410. This step involves the collection of responses from the evaluator LLM. The evaluator LLM, which is a more advanced model, generates responses based on the evaluation prompts it receives. These responses are a reflection of the evaluator LLM's interpretation and understanding of the prompts, providing beneficial data for the evaluation process.

The responses generated by the evaluator LLM are not just simple outputs; they are complex constructs that encapsulate the LLM's capabilities, knowledge, and reasoning. They are the product of the LLM's internal processes, which involve interpreting the prompts, accessing its knowledge base, applying its reasoning capabilities, and generating a response that it deems appropriate. These responses are collected by the auto evaluation system for further processing.

The collection of responses is a meticulous process that ensures the integrity and completeness of the data. The system collects the responses generated by the evaluator LLM, ensuring that no data is lost or overlooked. This comprehensive collection of responses provides a rich dataset for steps of the auto evaluation process.

In some cases, the system may also record additional information about the responses, such as the time taken by the evaluator LLM to generate the responses or any errors or issues encountered during the response generation. This additional information can provide beneficial insights into the performance and efficiency of the evaluator LLM, which can be used to further refine the auto evaluation process.

In essence, the response collection step 410 provides the raw data that forms the basis for the evaluation of the test LLM's performance.

The responses are processed in the metric extraction step 412. In this step, the responses are parsed to extract evaluation metrics. NLP techniques may be applied to interpret the responses from the test LLM. The extracted metrics may be identified and categorized into quantitative and qualitative data for the test LLM.

In the metric extraction step 412, the responses generated by the test LLM in response to the evaluation prompts are processed. This processing involves parsing the responses to extract the evaluation metrics. Parsing is a process of analyzing a string of symbols, either in natural language or in computer languages, according to the rules of a formal grammar. In this context, the responses from the test LLM are parsed to extract the relevant metrics that will be used for the evaluation.

The parsing process may involve the application of NLP techniques. NLP is a subfield of artificial intelligence that focuses on the interaction between computers and humans through natural language. An objective of NLP is to read, decipher, understand, and make sense of human language in a beneficial way. By applying NLP techniques, the system can interpret the responses from the test LLM, understanding the context, semantics, and sentiment of the responses.

Once the responses have been parsed and interpreted, the extracted metrics are identified. These metrics represent the various aspects of the test LLM's performance that are being evaluated. The metrics may include a wide range of factors, such as the accuracy of the LLM's responses, the relevance of the responses to the prompts, the fluency of the generated text, among others.

After the metrics have been identified, they are categorized into quantitative and qualitative data for the test LLM. Quantitative data refers to numerical data that can be measured or counted. In the context of LLM evaluation, quantitative data may include metrics such as the accuracy of the LLM's responses, the speed of response generation, or the length of the generated responses. On the other hand, qualitative data refers to non-numerical data that provides descriptive information. For LLM evaluation, qualitative data may include metrics such as the coherence of the LLM's responses, the relevance of the responses to the prompts, or the fluency of the generated text. By categorizing the metrics into quantitative and qualitative data, the system can provide a comprehensive and multi-faceted evaluation of the test LLM's performance.

The process proceeds to the score computation step 414 where the auto evaluation scores are computed using the metrics that have been extracted from the responses of the test LLM. These metrics, which have been parsed and categorized into quantitative and qualitative data in the previous step, serve as the raw data for the computation of the evaluation scores.

The computation of the evaluation scores involves applying statistical analysis to the extracted metrics. This statistical analysis may involve various techniques such as descriptive statistics, inferential statistics, or predictive statistics, depending on the nature of the metrics and the requirements of the evaluation process. Descriptive statistics may be used to summarize the metrics and provide a general overview of the test LLM's performance. Inferential statistics may be used to make inferences about the LLM's performance based on the sample data. Predictive statistics may be used to predict future performance of the LLM based on the current data.

The application of statistical analysis to the extracted metrics ensures that the evaluation scores are not just a simple aggregation of the metrics, but a meaningful and insightful representation of the test LLM's performance. The statistical analysis takes into account the distribution, variability, and relationships among the metrics, providing a comprehensive and nuanced assessment of the LLM's performance.

In addition to the statistical analysis, the evaluation scores may also be normalized to account for variations in the input data from the test LLM. Normalization is a process that adjusts the values of the metrics to a common scale, without distorting the differences in the ranges of values or losing information. This is particularly useful when the input data varies widely in scale, range, or units, as it ensures that metrics are treated equally in the computation of the evaluation scores.

Normalization of the evaluation scores ensures that the scores are comparable and interpretable, regardless of the variations in the input data. It also ensures that the evaluation process is fair and unbiased, as it prevents any metric from dominating the evaluation scores due to its scale or range. This is particularly relevant in the context of LLM evaluation, where the input data can vary widely in terms of complexity, length, format, and other factors.

The process proceeds with the evaluation score output step 416. During this step, the evaluation scores are provided for the user's analysis. The evaluation scores for the test LLM may be displayed in a user interface. A detailed report that includes the evaluation scores and an analysis of the performance of the test LLM may also be generated.

The evaluation score output step 416, the computed evaluation scores are made available for the user's analysis. This step brings together the various components of the auto evaluation process to produce a comprehensive evaluation of the test LLM's performance.

The evaluation scores for the test LLM, which are a quantitative measure of the LLM's performance based on the selected metrics, are displayed in a user interface. This user interface may be a GUI that presents the evaluation scores in a visually intuitive manner, making it easy for users to understand and interpret the results. The user interface may also provide interactive features that allow users to explore the evaluation results in more detail, such as by viewing the scores for individual metrics or by comparing the scores across different LLMs or evaluation runs.

In addition to displaying the evaluation scores in a user interface, a detailed report is also generated. This report includes the evaluation scores and an in-depth analysis of the performance of the test LLM. The analysis provides a comprehensive overview of the test LLM's performance, detailing how the LLM performed on each metric and highlighting any areas of strength or weakness. The report may also include a summary of the evaluation process, outlining the metrics used, the evaluation prompts generated, and the responses received from the test LLM. This detailed report serves as a beneficial resource for users, providing them with a thorough understanding of the test LLM's capabilities and performance. It can be used for various purposes, such as for reviewing the LLM's performance, for making decisions about deploying or improving the LLM, or for sharing the evaluation results with other stakeholders.

In some aspects, the auto evaluation execution process may be repeated for different LLMs or for different evaluation metrics. This flexibility allows the hierarchical auto evaluation system to support a broad range of tasks and to adapt to the evolving landscape of LLM applications.

It is noted that the creation of a new child class as described above may not be necessary in every instance. For example, if the metric is already established within the auto evaluation hierarchy, a corresponding pre-existing child class may be utilized, thereby eliminating the creation of a new redundant child class. For example, upon the initial evaluation of a tax-specific LLM, a new tax-specific child class would be created. However, for subsequent evaluations involving the same tax-specific metrics, this established child class would be reused.

Furthermore, it is also noted that the hierarchical nature of the system allows for the new child class to be created not just off the base class but also from an existing class that is already a child of the base class (i.e., child of the child, etc.). This flexibility exemplifies the power of the hierarchical structure, where the new class can be constructed at any layer within the family tree of existing metric classes, based on the nuanced requirements of the new metric. This approach ensures that the system can adapt to the evolving landscape of LLM applications and the diverse range of tasks they perform, while also avoiding unnecessary processing.

This hierarchical structure is a practical tool that can be leveraged to create a wide array of evaluation metrics. For instance, if a new metric is closely related to an existing one but requires some additional logic or parameters, it can be created as a child of the existing metric class, inheriting all of its properties and functions. This way, the new metric can leverage the existing logic and parameters and add or override just the parts that are different. This saves time and effort, and also reduces the risk of errors or inconsistencies that could arise if the new metric was created from scratch.

Moreover, as mentioned above, this hierarchical structure is not limited to a single level of inheritance. A child class can itself be a parent to other classes, creating a multi-level hierarchy. This allows for even more nuanced and specialized metrics to be created, each tailored to a specific task or domain. Each level of the hierarchy adds more specificity, allowing the system to handle a wide range of tasks with high precision.

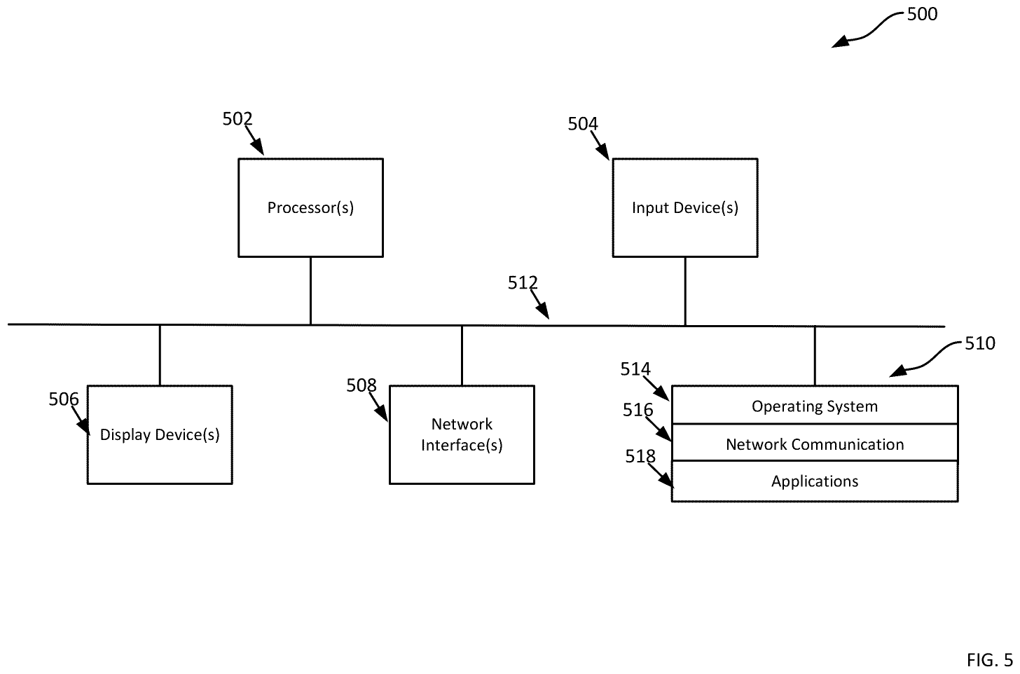

FIG. 5 is a diagram illustrating a computing system 500 that may be used to implement the hierarchical auto evaluation system. The computing system 500 includes a processor block 502, which is centrally located and connected to other components via a communication bus 512. The processor block 502 may be a central processing unit (CPU), a graphics processing unit (GPU), or any other type of processing unit that can execute instructions and process data.

An input device block 504 and a display device block 506 are connected to the processor block 502, facilitating user interaction and visual output, respectively. The input device block 504 may include devices such as a keyboard, a mouse, a touchscreen, or any other device that allows a user to input data or commands into the computing system 500. The display device block 506 may include devices such as a monitor, a projector, a touchscreen, or any other device that can display visual output from the computing system 500.

A network interface block 508 provides connectivity capabilities, interfacing with the processor block 502. The network interface block 508 may include a network adapter, a wireless adapter, or any other device that allows the computing system 500 to connect to a network, such as the network cloud 110 depicted in FIG. 1.

The software layer 510 encompasses an operating system block 514 and a network communication block 516, which manage the system's operations and network communications. The operating system block 514 may include software that manages hardware resources and provides services for software applications. The network communication block 516 may include software that manages network connections and facilitates data transmission over the network.

Additionally, applications block 518 is included within the software layer 510, representing the various applications that run on the computing system 500. These applications may include the auto evaluation server 106, the judge LLM server 104, and the test LLM server 108, as depicted in FIG. 1. The applications block 518 may also include other software applications that are used to implement the hierarchical auto evaluation system. In some aspects, the computing system 500 may be configured to execute the methods described in FIGS. 2, 3, and 4.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed:

1. An auto evaluation system for evaluating large language models (LLMs), comprising:
an auto evaluation server configured to:
initialize an auto evaluation process by loading a base auto evaluation class with core functionalities,
select one or more metrics for evaluation,
extend the base auto evaluation class to create a child class with additional functionalities tailored to the selected metrics,
receive input data and configuration settings for the evaluation, and
construct evaluation prompts using the child class based on the input data and the configuration settings; and
a judge LLM server configured to:
receive the evaluation prompts from the auto evaluation server for response generation by a test LLM,
parse responses from the test LLM to extract metrics,
compute evaluation scores based on the extracted metrics from the test LLM, and
output the evaluation scores for the test LLM.

2. The system of claim 1, wherein the auto evaluation server is further configured to:
load the base auto evaluation class from a repository containing multiple evaluation classes, and
verify compatibility of the base auto evaluation class with the auto evaluation server.

3. The system of claim 1, wherein the auto evaluation server is further configured to:
present a user interface to a user to select the one or more metrics from a predefined list, and
enable the user to define custom metrics for the evaluation of the test LLM.

4. The system of claim 1, wherein the auto evaluation server is further configured to:
inherit properties and methods from the base auto evaluation class, and
add methods for processing specific types of the input data related to the selected metrics for evaluating the test LLM.

5. The system of claim 1, wherein the auto evaluation server is further configured to:
accept the input data in multiple formats including text, audio, and image data, and
receive the configuration settings that include evaluation criteria and thresholds for the test LLM.

6. The system of claim 1, wherein the auto evaluation server is further configured to:
utilize templates for generating prompts that are specific to the selected metrics for evaluating the test LLM, and
incorporate variability in the prompts to test different aspects of capabilities of the test LLM.

7. The system of claim 1, wherein the auto evaluation server is further configured to:
transmit the evaluation prompts to the judge LLM server via a secure communication protocol for evaluation of the test LLM, and
log details of the transmitting for audit and verification purposes.

8. The system of claim 1, wherein the judge LLM server is further configured to:
apply natural language processing techniques to interpret the responses from the test LLM, and
identify and categorize the extracted metrics into quantitative and qualitative data for the test LLM.

9. The system of claim 1, wherein the judge LLM server is further configured to:
apply statistical analysis to the extracted metrics from the test LLM to determine the evaluation scores, and
normalize the evaluation scores to account for variations in the input data from the test LLM.

10. The system of claim 1, wherein the judge LLM server is further configured to:
display the evaluation scores for the test LLM in a user interface, and
generate a detailed report that includes the evaluation scores and an analysis of a performance of the test LLM.

11. A method for evaluating large language models (LLMs), performed by an auto evaluation server in communication with a judge LLM, the method comprising:
initializing an auto evaluation process by loading a base auto evaluation class with core functionalities;
selecting one or more metrics for evaluation;
extending the base auto evaluation class to create a child class with additional functionalities tailored to the selected metrics;
receiving input data and configuration settings for the evaluation of a test LLM;
constructing evaluation prompts using the child class based on the input data and the configuration settings for the test LLM;
communicating the evaluation prompts to the judge LLM for response generation by the test LLM;
parsing responses received from the test LLM to extract metrics;
computing evaluation scores based on the extracted metrics from the test LLM; and
outputting the evaluation scores for the test LLM.

12. The method of claim 11, wherein the initializing further comprises:
loading the base auto evaluation class from a repository containing multiple evaluation classes; and
verifying compatibility of the base auto evaluation class with the auto evaluation server.

13. The method of claim 11, wherein the selecting further comprises:
presenting a user interface to a user to select the one or more metrics from a predefined list; and
enabling the user to define custom metrics for the evaluation of the test LLM.

14. The method of claim 11, wherein the extending further comprises:
inheriting properties and methods from the base auto evaluation class; and
adding methods for processing specific types of the input data related to the selected metrics for evaluating the test LLM.

15. The method of claim 11, wherein the receiving further comprises:
accepting the input data in multiple formats including text, audio, and image data; and
receiving the configuration settings that include evaluation criteria and thresholds for the test LLM.

16. The method of claim 11, wherein the constructing further comprises:
utilizing templates for generating prompts that are specific to the selected metrics for evaluating the test LLM; and
incorporating variability in the prompts to test different aspects of capabilities of the test LLM.

17. The method of claim 11, wherein the communicating further comprises:
transmitting the evaluation prompts to the judge LLM via a secure communication protocol for evaluation of the test LLM; and
logging details of the transmitting for audit and verification purposes.

18. The method of claim 11, wherein the parsing further comprises:
applying natural language processing techniques to interpret the responses from the test LLM; and
identifying and categorizing the extracted metrics into quantitative and qualitative data for the test LLM.

19. The method of claim 11, wherein the computing further comprises:
applying statistical analysis to the extracted metrics from the test LLM to determine the evaluation scores; and
normalizing the evaluation scores to account for variations in the input data from the test LLM.

20. The method of claim 11, wherein the outputting further comprises:
displaying the evaluation scores for the test LLM in a user interface; and
generating a detailed report that includes the evaluation scores and an analysis of a performance of the test LLM.
